(19) United States
(12) Patent Application Publication
(10) Pub. No.: US 2026/0302498 A1
(43) Pub. Date: Oct. 1, 2026

(54) Battery Box

(71) Applicant: Nanning FuLian FuGui Precision Industrial Co., Ltd., Nanning (CN)

(72) Inventor: YING-XING WEI, Nanning (CN)

(21) Appl. No.: 19/180,372

(22) Filed: Apr. 16, 2025

(30) Foreign Application Priority Data
Mar. 27, 2025 (CN) 202510377178.6

(51) Int. Cl. H01M 50/291; H01M 50/271

(52) U.S. Cl. CPC H01M 50/291; H01M 50/271

(57) ABSTRACT

A battery box includes a housing, a main base, a holding frame, and a driving mechanism. The main base is affixed in the housing. The holding frame is rotatably disposed in the housing. The driving mechanism is disposed in the housing. The main base and the holding frame are configured to accommodate a battery therein between. The holding frame is rotatable from a storage position to an expansion position and the battery is lifted, by operating the driving mechanism.

### FIELD

The subject matter herein generally relates to battery boxes.

### BACKGROUND

Batteries are installed in a mobile device to provide power to the mobile device. In order to facilitate battery replacement, a battery box is usually set up in the mobile device to accommodate batteries in compliance with certain specifications be installed in the battery groove of the battery box. In addition, the battery groove in the battery box also need to match a size of the battery to prevent the battery from shifting in the battery groove and become separated from the electrodes of the battery box.

However, the battery in the battery box may be swollen due to factors such as service life or defects. In particular, rechargeable batteries become swollen due to excessive charging and discharging. The battery is usually installed when the battery is new or fully charged, and then removed later when the battery is out of power or has insufficient power. During removal of the battery, the battery may stuck in the battery groove because of the swollen, making it difficult to remove and replace, resulting in the inability to provide power to the mobile device.

### BRIEF DESCRIPTION OF THE DRAWINGS

Many aspects of the present disclosure are better understood with reference to the following drawings. The components in the drawings are not necessarily drawn to scale, the emphasis instead being placed upon clearly illustrating the principles of the present disclosure. It will be appreciated that for simplicity and clarity of illustration, where appropriate, reference numerals have been repeated among the different figures to indicate corresponding or analogous elements.

FIG. 1 is a perspective view of a battery box in accordance with an embodiment of the present disclosure.

FIG. 2 is an exploded view of the battery box shown in FIG. 1.

FIG. 3 is a cross-sectional view of section A-A in FIG. 1.

FIG. 4 is a perspective view of a driving mechanism shown in FIG. 2.

FIG. 5 is a cross-sectional view of section A-A in FIG. 1, wherein a holding frame is rotated to an expansion position by the driving mechanism.

FIG. 6 is a perspective view of the driving mechanism shown in FIG. 2, and a movement element is moved to a lifting position.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

The disclosure is illustrated by way of embodiments and not by way of limitation in the figures of the accompanying drawings, in which like references indicate similar elements. It should be noted that references to “an” or “one” embodiment in this disclosure are not necessarily to the same embodiment, and such references mean “at least one.”

The term “connect” is defined as directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series, and the like.

In the present disclosure, swollen batteries can be easily taken out from the battery box by changing the size of battery grooves in the battery box and by lifting batteries.

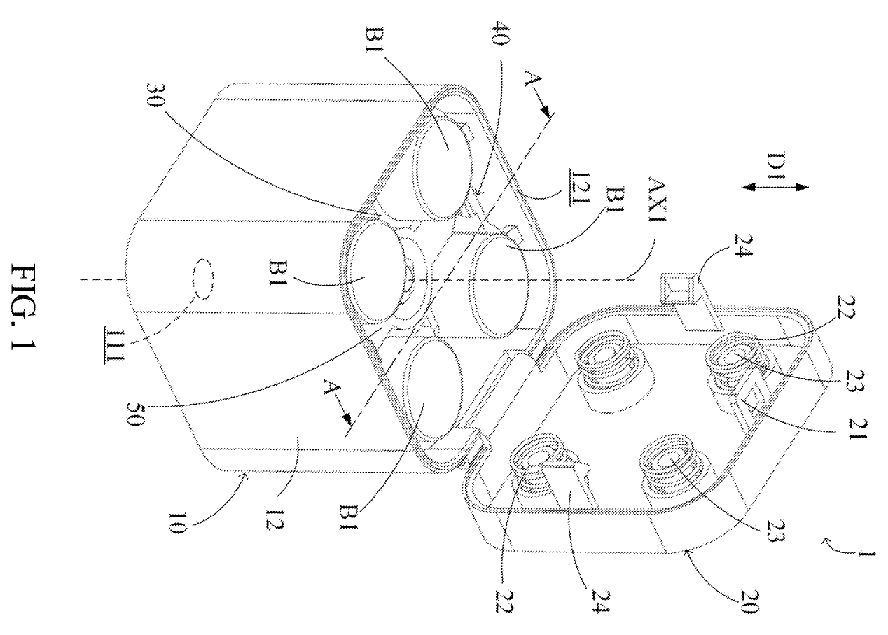

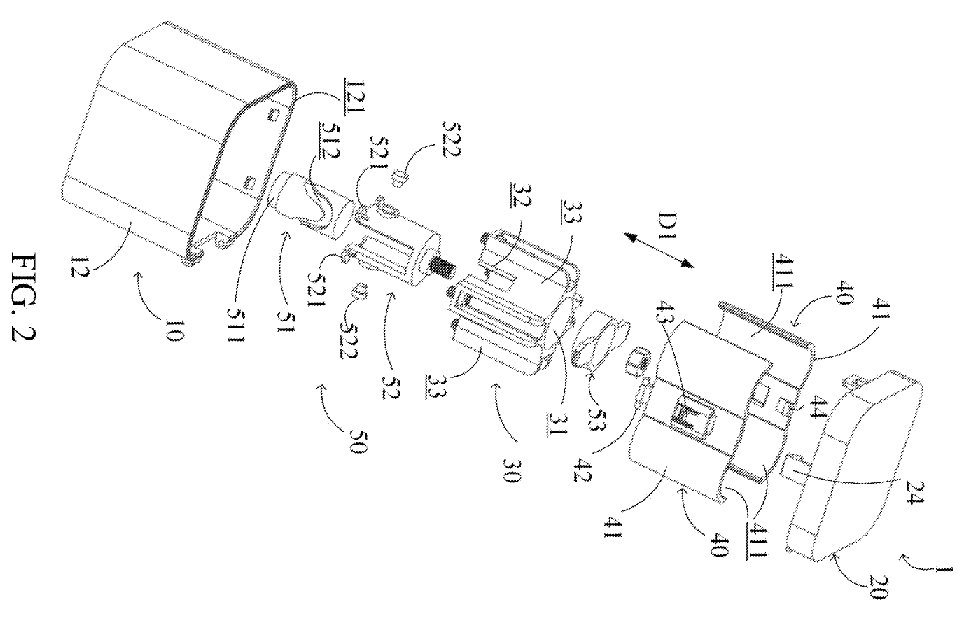

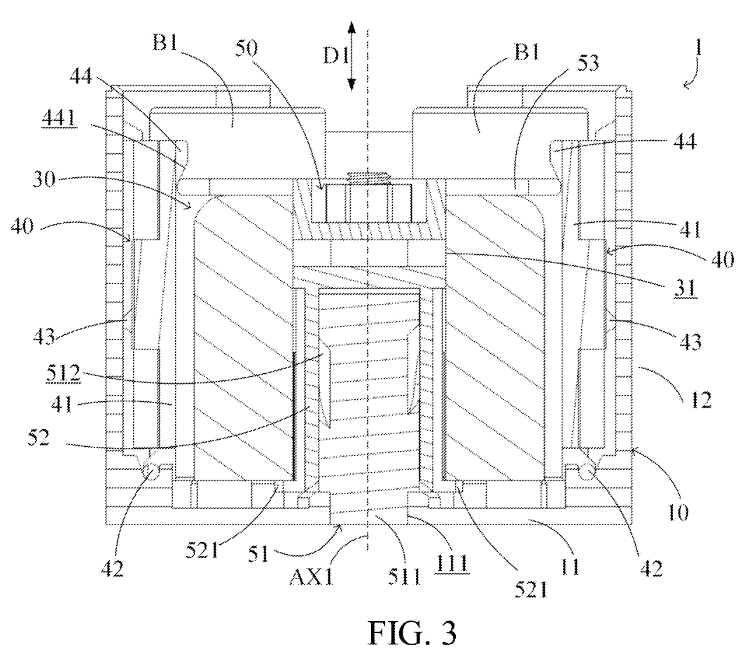

FIG. 1 is a perspective view of a battery box 1 in accordance with an embodiment of the present disclosure. FIG. 2 is an exploded view of the battery box 1 shown in FIG. 1. FIG. 3 is a cross-sectional view of section A-A in FIG. 1. The battery box 1 is used to provide power to an electronic device. The battery box 1 can be disposed in the electronic device, or detachably mounted to the electronic device. The battery box 1 can accommodate batteries B1. The batteries B1 may be dry batteries or cylindrical batteries. In another embodiment, the battery box 1 can accommodate one battery B1.

The battery box 1 includes a housing 10, a cover 20, a main base 30, two holding frames (a first holding frame and a second holding frame) 40, and a driving mechanism 50. The housing 10 includes a bottom portion 11 and a side wall 12. The bottom portion 11 has a bottom opening 111. The side wall 12 extends perpendicular to the bottom portion 11, and may be a ring-like structure. The side wall 12 has a top opening 121. The top opening 121 is separated from the bottom opening 111, and extends parallel to the bottom opening 111. An imaginary central axis AX1 extends through the center of the bottom opening 111 and the center of the top opening 121, and the side wall 12 surrounds the imaginary central axis AX1.

The cover 20 is connected to the housing 10. In the embodiment, the cover 20 is rotatably connected to the top of the side wall 12, and is used to cover the top opening 121 of the side wall 12. The cover 20 includes a buckle 21, electrode springs 22, and guard posts 23. When the cover 20 covers the top opening 121 of the side wall 12, the buckle 21 is fastened to the side wall 12 of the housing 10, the electrode springs 22 contact the batteries B1 respectively. The guard posts 23 are respectively in the electrode springs 22. When the cover 20 covers the top opening 121, the guard posts 23 connect the negative electrodes of batteries B1 as shown in FIG. 1. If the batteries B1 are mounted in the battery box 1 in the opposite direction, the guard posts 23 contact the positive electrodes of the batteries B1, which further cause the buckle 21 to be unable to fasten to the side wall 12 of the housing 10, thereby prompting the user that the battery B1 should be installed in the battery box 1 in the wrong direction.

The main base 30 is affixed into the housing 10. In the embodiment, the main base 30 is affixed to the bottom portion 11 of the housing 10. The side wall 12 of the housing 10 surrounds the main base 30, and is separated from the main base 30. The main base 30 includes a receiving groove 31, restriction slots 32, and main battery grooves 33. The receiving groove 31, the restriction slots 32, and the main battery grooves 33 extend in a movement direction D1. In other words, a receiving groove 31, restriction slots 32, and main battery grooves 33 are parallel to each other. The movement direction D1 is parallel to the imaginary central axis AX1. The imaginary central axis AX1 extends through the center of the receiving groove 31, and the receiving groove 31 extends along the imaginary central axis AX1. In other words, the receiving groove 31 is positioned correspondingly to the bottom opening 111. The restriction slots 32 are arranged around the imaginary central axis AX1, and connected to the receiving groove 31. The main battery grooves 33 are arranged around the imaginary central axis AX1, and connected to the restriction slot 32.

In the embodiment, each main battery groove 33 is positioned correspondingly to one restriction slot 32. In other words, each restriction slot 32 is between one receiving groove 31 and one main battery groove 33, which is connected to the one receiving groove 31. The main base 30 includes four main battery grooves 33 and four restriction slots 32. Each battery B1 is used to be placed in one main battery groove 33.

Two holding frames 40 are respectively rotatably disposed in the housing 10, and the main base 30 is between the holding frames 40. In FIG. 1 and FIG. 3, the holding frames 40 are in a storage position. Each battery B1 is to be placed between the main base 30 and the holding frame 40. The pivoting ends of the holding frames 40 are respectively rotatably disposed on the bottom portion 11 of the housing 10.

Each holding frame 40 includes a holding body 41, a shaft 42, an elastic arm 43, and a wedge 44. The holding body 41, the shaft 42, the elastic arm 43, and the wedge 44 can be an integrally formed structure, and can be made of the same materials, such as plastic. Each holding body 41 is between the main base 30 and the side wall 12 of the housing 10. Each holding body 41 includes one or more outer battery grooves 411. Battery grooves are formed by the outer battery grooves 411, the main battery grooves 33, and the areas between the outer battery grooves 411 and the main battery grooves 33. The batteries B1 are accommodated in the battery grooves. However, the number of outer battery grooves 411 is not limited. Each outer battery groove 411 may be positioned correspondingly to one main battery groove 33. Each battery B1 may be accommodated in one adjacent main battery groove 33 and one adjacent outer battery groove 411.

Each shaft 42 is disposed on the pivoting end of the holding body 41 of the holding frame 40, and rotatably connected to the bottom portion 11 of the housing 10. Each elastic arm 43 is disponed on the holding body 41, and faces the side wall 12 of the housing 10. The elastic arm 43 abuts the side wall 12 of the housing 10, and configured to maintain the holding frame 40 in the storage position. Each wedge 44 is disposed on the holding body 41, and faces the imaginary central axis AX1. In the embodiment, the wedge 44 is adjacent to the free end of the holding body 41 of the holding frame 40. The free end of the holding body 41 is opposite to the pivoting end. The free end of the holding body 41 is adjacent to the top opening 121 or the cover 20. The pivoting end of the holding body 41 is adjacent to the bottom portion 11 of the housing 10. In other words, the pivoting end of the holding body 41 is closer to the shaft 42 or the bottom portion 11 of the housing 10 than the free end of the holding body 41.

In the embodiment, the cover 20 further includes buffer elements 24. When the cover 20 covers the housing 10, each buffer element 24 is between the free end of the holding frame 40 and the housing 10, and is used to maintain the holding frame 40 in the storage position.

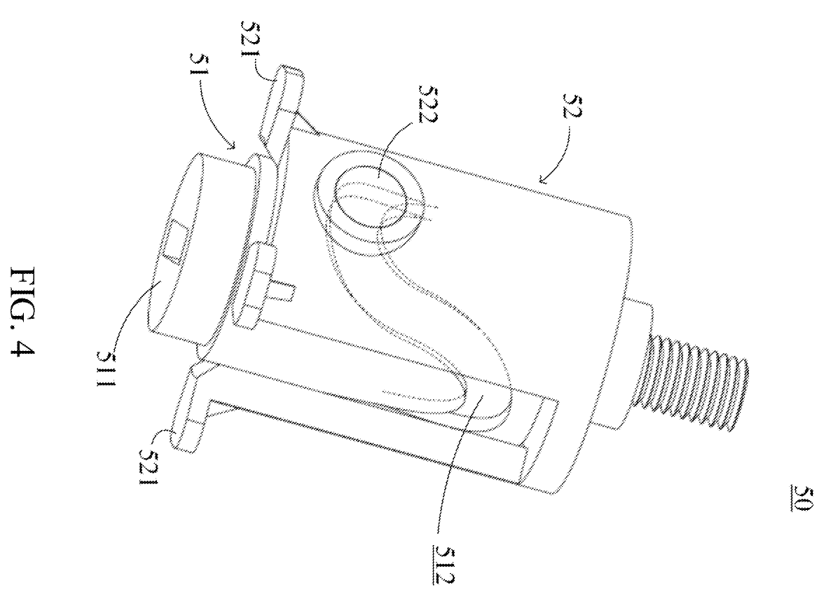

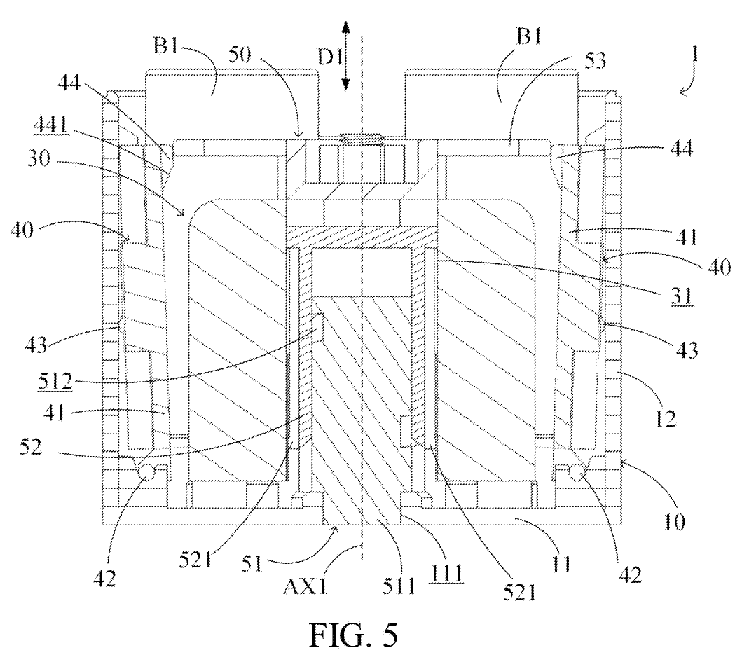

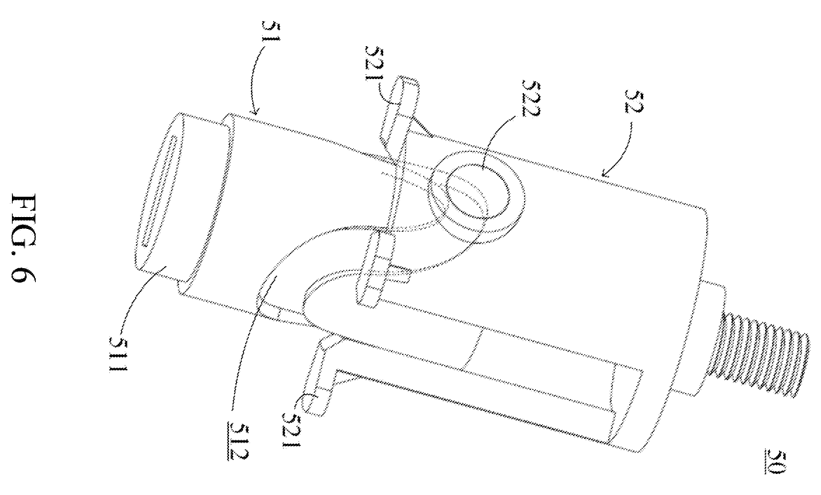

FIG. 4 is a perspective view of the driving mechanism 50 shown in FIG. 2. FIG. 5 is a cross-sectional view of section A-A in FIG. 1, wherein the holding frame 40 is rotated to an expansion position by the driving mechanism 50. FIG. 6 is a perspective view of the driving mechanism 50 shown in FIG. 2, and the movement element 52 is moved to a lifting position. The driving mechanism 50 is disposed in the housing 10. In the embodiment, the driving mechanism 50 is in the receiving groove 31 of the main base 30, and the driving mechanism 50 is accessible through the bottom opening 111. In other words, the driving mechanism 50 is exposed from the bottom opening 111 of the housing 10, and the bottom opening 111 exposes the driving mechanism 50 to an exterior of the battery box. When the driving mechanism 50 is operated to rotate the holding frame 40 from the storage position of FIG. 3 to the expansion position of FIG. 5, the driving mechanism 50 further lifts the batteries B1, so that the batteries B1 move upward in the movement direction D1 and toward the top opening 121.

The driving mechanism 50 includes a rotation element 51, a movement element 52, and a pushing element 53. The rotation element 51 is rotatably disposed in the receiving groove 31 of the main base 30. The rotation element 51 can be rotated about the imaginary central axis AX1. In other words, the imaginary central axis AX1 extends through the center of the rotation element 51. The rotation element 51 includes a protrusion portion 511 and a wavy groove 512. The protrusion portion 511 is in the bottom opening 111 of the housing 10. The wavy groove 512 is formed on the side wall of the rotation element 51. The wavy groove 512 surrounds the imaginary central axis AX1.

The movement element 52 is movably disposed on the rotation element 51, and the movement element 52 is movably disposed in the receiving groove 31 of the main base 30. In the embodiment, the movement element 52 may be a hollow structure, and cover the side wall of the rotation element 51. The imaginary central axis AX1 extends through the center of the movement element 52. The movement element 52 includes lifting blocks 521 and guiding posts 522. Each lifting block 521 extends through one of the restriction slot 32. The restriction slot 32 is used to restrict the movement element 52 moving in the movement direction D1. The guiding post 522 is disposed on the movement element 52, and in the wavy groove 512. Therefore, when the rotation element 51 is rotated relative to the housing 10, the movement of the movement element 52 relative to the rotation element 51 is restricted in the movement direction D1.

Moreover, the lifting blocks 521 are under the bottoms of the batteries B1. When the rotation element 51 is rotated relative to the housing 10, the rotation element 51 lifts the movement element 52, so as to move the movement element 52 from an initial position in FIGS. 3 and 4 to the lifting position in FIGS. 5 and 6, and to lift the batteries B1 in the movement direction D1 by the lifting block 521 of the movement element 52. When the rotation element 51 is continually rotated relative to the housing 10, the rotation element 51 can lower the movement element 52 in the movement direction D1, so as to move the movement element 52 from the lifting position in FIGS. 5 and 6 to the initial position in FIGS. 3 and 4.

The pushing element 53 is disposed on the movement element 52, and on the main base 30. In the embodiment, a portion of the pushing element 53 is in the receiving groove 31. When the rotation element 51 is rotated relative to the housing 10, the movement element 52 can be lifted in the movement direction D1, thereby causing the pushing element 53 to rise in the movement direction D1. When the pushing element 53 is lifted, the pushing element 53 pushes the free ends of the holding frames 40, so that the holding frames 40 are rotated from the storage position to the expansion position.

In the embodiment, the wedge 44 of the holding frame 40 includes an inclined surface 441. When the rotation element 51 lifts the movement element 52, the pushing element 53 is moved in the inclined surface 441, thereby pushing the holding frame 40 to rotate, and causing the free ends of the holding frames 40 to move away from the imaginary central axis and toward the side wall 12 of the housing 10.

As shown in FIGS. 1 to 4, the holding frames 40 are in the storage position, and the movement element 52 is in the initial position. As shown in FIG. 4, when the movement element 52 is in the initial position, the guiding post 522 is in the lower end of the wavy groove 512. Each battery B1 is placed in the main battery groove 33 of the main base 30, and the outer battery groove 411 of the holding frame 40. When the cover 20 covers the housing 10, the buckle 21 of the cover 20 is fastened to the housing 10 to prevent the cover 20 from opening relative to the housing 10. The electrode springs 22 contact the batteries B1, so that battery box 1 can start supplying power. Moreover, each buffer element 24 is between the free end of the holding frame 40 and the housing 10, so as to maintain the holding frame 40 in the storage position. Therefore, this is to prevent the batteries B1 from being separated from the electrode springs 22 when the battery box 1 is collided.

If swollen batteries B1 are stuck in the battery slot and are difficult to remove from battery box 1, the user can open the cover 20 relative to the housing 10, and then use a tool such as a screwdriver to rotate the protrusion portion 511, so as to rotate the rotation element 51 relative to the movement element 52. At this time, the guiding post 522 can be moved from the lower end of the wavy groove 512 in FIG. 4 to the upper end of the wavy groove 512 in FIG. 6, so as to move the movement element 52 from the initial position in the movement direction D1 shown in FIGS. 3 and 4 to the lifting position shown in FIGS. 5 and 6. In the embodiment, the lower end of the wavy groove 512 is closer to the bottom portion 11 of the housing 10 and the protrusion portion 511 of the rotation element 51 than the upper end of the wavy groove 512.

In the embodiment, when the rotation element 51 is further rotated relative to the movement element 52, the guiding post 522 is moved from the upper end of the wavy groove 512 in FIG. 6 to the lower end of the wavy groove 512 in FIG. 4, so as to move the movement element 52 from the lifting position in FIGS. 5 and 6 to the initial position in FIGS. 3 and 4. In other words, when the rotation element 51 is continually rotated relative to the movement element 52, the movement element 52 repeatedly moves between the initial position and the lifting position. When the movement element 52 is rotated from the lifting position to the initial position, the elastic arm 43 can rotate the holding frame 40 from the expansion position to the storage position.

When the movement element 52 is in the lifting position, the movement element 52 lifts the pushing element 53. The pushing element 53 slides along the inclined surface 441, thereby pushing the second holding frame 40 to rotate and making the free end of the holding frame 40 away from the imaginary central axis AX1. In other words, when the pushing element 53 is lifted, the holding frame 40 is rotated from the storage position in FIG. 3 to the expansion position in FIG. 5. The distance between the free end of the holding frame 40 and the main base 30 when the holding frame 40 in the expansion position is longer than the distance between the free end of the holding frame and the main base 30 when the holding frame 40 in the storage position. The distance between the free ends of the holding frames 40 in the expansion position is longer than the distance between the free ends of the holding frames in the storage position. Therefore, when the holding frame 40 in the expansion position, the space of the battery groove is increased, the holding frames 40 release the swollen batteries B1, allowing the user to easily take batteries B1 out of the battery box 1.

In addition, when the movement element 52 is moved from the initial position to the lifting position, the lifting blocks 521 under the bottom of batteries B1 are further lifted. Therefore, the lifting blocks 521 lift the batteries B1 toward the top opening 121 of the housing 10, so that the user can more conveniently take the batteries B1 out of the battery box 1.

In conclusion, the holding frames 40 are rotated to expand the space of the battery grooves by operating the restriction element 50, so as to releasing expanded batteries in the battery box 1. Moreover, when the driving mechanism 50 is operated, the driving mechanism 50 can further lift the batteries B1, so that the user can easily take the expanded batteries B1 out of the battery box 1.

Many details are often found in the relevant art, thus many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will, therefore, be appreciated that the embodiments described above may be modified within the scope of the claims.

What is claimed is:

1. A battery box comprising:
a housing;
a main base affixed into the housing; and
a holding frame rotatably disposed in the housing; and
a driving mechanism disposed in the housing,
wherein the main base and the holding frame are configured to accommodate a battery therein between, and
the holding frame is rotatable from a storage position to an expansion position and the battery is lifted, by operating the driving mechanism.

2. The battery box as claimed in claim 1, wherein the main base comprises a main battery groove, the holding frame comprises an outer battery groove, and the battery is accommodated in the main battery groove and the outer battery groove.

3. The battery box as claimed in claim 1, wherein a distance from a free end of the holding frame to the main base when the holding frame is in the expansion position is longer than a distance of the free end of the holding frame to the main base when the holding frame is in the storage position.

4. The battery box as claimed in claim 1, wherein the driving mechanism is disposed in the main base, the housing comprises a bottom opening exposing the driving mechanism to an exterior of the battery box.

5. The battery box as claimed in claim 1, wherein the driving mechanism comprises:
a rotation element rotatably disposed in the main base; and
a movement element movably disposed on the rotation element,
wherein when the rotation element is rotated relative to the housing, the rotation element lifts the movement element, thereby causing the movement element to lift the battery.

6. The battery box as claimed in claim 5, wherein the rotation element comprises a wavy groove, the movement element comprises a guiding post disposed in the wavy groove,
when the rotation element is rotated relative to the housing, the movement element is moved relative to the rotation element in a movement direction.

7. The battery box as claimed in claim 5, wherein the main base comprises a restriction slot, the movement element further comprises a lifting block, the lifting block extends through the restriction slot, and the restriction slot is configured to restrict the movement element from moving in a movement direction.

8. The battery box as claimed in claim 5, wherein the driving mechanism further comprising:
a pushing element disposed on the movement element and the main base,
wherein when the rotation element is rotated relative to the housing, the pushing element rotates the holding frame from the storage position to the expansion position.

9. The battery box as claimed in claim 8, wherein the holding frame further comprising:
a wedge adjacent to a free end of the holding frame, and the wedge comprising an inclined surface,
wherein when the rotation element lifts the movement element, the pushing element slides along the inclined surface.

10. The battery box as claimed in claim 1, wherein the holding frame comprises an elastic arm abutting the housing, and configured to maintain the holding frame in the storage position.

11. The battery box as claimed in claim 1, further comprising:
a cover connected to the housing, and comprising a buffer element,
wherein when the cover covers the housing, the buffer element is between a free end of the holding frame and the housing, and configured to maintain the holding frame in the storage position.

12. A battery box comprising:
a housing;
two holding frames respectively rotatably disposed in the housing;
a main base affixed into the housing, and between the two holding frames; and
a driving mechanism disposed in the housing;
wherein the main base and the two holding frames are configured to accommodate a plurality of batteries therein between, and
the two holding frames are rotatable from a storage position to an expansion position and the batteries are lifted, by operating the driving mechanism.

13. The battery box as claimed in claim 12, wherein two pivoting ends of each of the two holding frames are respectively rotatably disposed on a bottom portion of the housing, and a distance between two free ends of the two holding frames in the expansion position is longer than a distance between the free ends of the two holding frames in the storage position, wherein the free ends of the two holding frames is opposite to the pivoting ends of the two holding frames.

14. The battery box as claimed in claim 12, wherein the driving mechanism comprises:
a rotation element rotatably disposed in the main base; and
a movement element disposed on the rotation element,
wherein when the rotation element is rotated relative to the housing, the rotation element lifts the movement element, thereby causing the movement element to lift the batteries.

15. The battery box as claimed in claim 14, wherein the driving mechanism further comprising:
a pushing element disposed on the movement element and the main base,
wherein when the rotation element is rotated relative to the housing, the pushing element rotates the two holding frames from the storage position to the expansion position.
